(19) United States
(12) Patent Application Publication
(10) Pub. No.: US 2019/0064767 A1
(43) Pub. Date: Feb. 28, 2019

(54) MANAGEMENT DEVICE AND MANAGEMENT METHOD

(71) Applicant: FANUC CORPORATION, Minamitsuru-gun (JP)

(72) Inventor: Kazuki SAKAMOTO, Yamanashi (JP)

(21) Appl. No.: 16/038,728

(22) Filed: Jul. 18, 2018

(30) Foreign Application Priority Data
Aug. 24, 2017 (JP) 2017-161238

(51) Int. Cl. G05B 19/4065; G05B 19/19; G05B 19/418

(52) U.S. Cl. CPC G05B 19/4065; G05B 19/401; G05B 19/4185; G05B 19/19

(57) ABSTRACT

To perform state monitoring that takes account of the arrangement of management target devices. A management device includes: a collection unit that collects, from each of a plurality of management target devices disposed in a management target location, environmental information which is information indicating a state of an environment in which said management target device is placed; and a display control unit that partitions the management target location into a plurality of regions, determines a state of an environment for each of the plurality of regions based on the environmental information collected by the collection unit, and displays the state of the environment for each of the plurality of regions thus determined on a display unit to be associated with a picture showing an arrangement of the management target devices in the management target location.

This application is based on and claims the benefit of priority from Japanese Patent Application No. 2017-161238, filed on 24 Aug. 2017, the content of which is incorporated herein by reference.

### BACKGROUND OF THE INVENTION

### Field of the Invention

The present invention relates to a management device and management method for managing a maintenance target device.

### Related Art

Conventionally, it has been common to carry out controlling machine tools that perform machining in a factory or the like with numerical control devices (CNC: Computerized Numerical Control). Numerical control devices are in a close relationship with machine tools, and normally monitor various information of the machine tool (for example, parameters of numerical control, measurement values by sensors, state of peripheral devices, etc.).

A system for centrally managing the information monitored by these numerical control devices is disclosed in Patent 17P00806US01 (FANF-316US) Document 1. With the system disclosed in Patent Document 1, the numerical control device incorporated into each machine tool and a server are connected by LAN (Local Area Network), and the server collects information monitored by the numerical control devices. Then, the server displays icons of each machine tool to be associated with the information of each machine tool. A user managing the factory becomes able to monitor the state of each machine tool, by referencing this display.

Patent Document 1:
Japanese Unexamined Patent Application, Publication No. H10-143232

### SUMMARY OF THE INVENTION

By utilizing common technology such as the aforementioned technology disclosed in Patent Document 1, it becomes possible to monitor the state of individual management target devices (e.g., machine tools). However, this is ultimately state monitoring of individual management target devices, and cannot perform state monitoring collectively by considering the arrangement of management target devices in the factory.

Therefore, the present invention has an object of providing a management device and management method for performing state monitoring collectively by considering the arrangement of management target devices. [0007]

A management device (for example, the management device 100 described later) according to a first aspect of the present invention includes: a collection unit (for example, the environmental information collection unit 11 described later) that collects, from each of a plurality of management target devices (for example, the management target device 200 described later) disposed in a management target location, environmental information which is information indicating a state of an environment in which said management target device is placed; and a display control unit (for example, the display control unit 12 described later) that partitions the management target location into a plurality of regions, determines a state of an environment for each of the plurality of regions based on the environmental information collected by the collection unit, and displays the state of the environment for each of the plurality of regions thus determined on a display unit (for example, the display unit 14 described later) to be associated with a picture showing an arrangement of the management target devices in the management target location.

According to a second aspect of the present invention, the management device as described in the first aspect may be configured so that the display control unit sets a threshold for a parameter included in the environmental information, and determines the state of the environment for each of the plurality of regions, based on whether the value of the parameter included in the environmental information collected by the collection unit) is exceeding the threshold thus set.

According to a third aspect of the present invention, the management device as described in the second aspect may be configured so that the display control unit determines step-wise the state of the environment for each of the plurality of regions by setting a plurality of the thresholds in a step-wise manner, and displays the state of the environment in a different mode according to which step a determined state is in.

According to a fourth aspect of the present invention, the management device as described in the third aspect may be configured so that displaying in a different mode according to which step the determined state is in indicates the matter of displaying using a different color according to which step the determined state is in.

According to a fifth aspect of the present invention, the management device as described in the any one of the second to fourth aspects may be configured so that the display control unit, in a case of collecting a plurality of sets of environmental information for a plurality of management target devices for one of the regions, performs the determination based on a highest value among values of parameters included in the plurality of sets of environmental information thus collected.

According to a sixth aspect of the present invention, the management device as described in the any one of the first to fifth aspects may be configured so as to further include a first operating state control unit (for example, the operating state control unit 13 described later) that controls an operating state of an environmental conditioning device that causes the state of the environment in which the management target device is placed to change, based on the state of the environment for each of the plurality of regions determined by the display control unit.

According to a seventh aspect of the present invention, the management device as described in the any one of the first to sixth aspects may be configured so as to further include a second operating state control unit (for example, the operating state control unit 13 described later) that controls an operating state of the management target device, based on the state of the environment for each of the plurality of regions determined by the display control unit.

According to an eighth aspect of the present invention, the management device as described in the any one of the first to seventh aspects may be configured so that the display control unit partitions the management target location into a plurality of regions, based on a manipulation by a user referencing an image showing an arrangement of the management target devices in the management target location.

A management method according to a ninth aspect of the present invention is a management method performed by a computer (for example, the management device 100 described later), the method including the steps of: collecting, from each of a plurality of management target devices (for example, the management target device 200 described later) disposed in a management target location, environmental information which is information indicating a state of an environment in which said management target device is placed; and partitioning the management target location into a plurality of regions, determining a state of an environment of each of the plurality of regions based on the environmental information collected in the step of collecting, and displaying the state of the environment determined for each the plurality of regions on a display unit (for example, the display unit 14 described later) to be associated with an image showing an arrangement of the management target devices in the management target location.

According to the present invention, it is possible to perform state monitoring collectively by considering the arrangement of management target devices.

### BRIEF DESCRIPTION OF THE DRAWINGS

FIG. 1 is a block diagram showing a basic configuration of an overall management system which is an embodiment of the present invention;

FIG. 2 is a block diagram showing a basic configuration of management device, management target device and environmental conditioning device in the embodiment of the present invention;

FIG. 3 is a flowchart showing basic operations of a management device of the embodiment of the present invention;

FIG. 4 is a schematic diagram showing an arrangement example of a management target device of the embodiment of the present invention;

FIG. 5 is a schematic diagram showing an example of an area division of the management target devices of the embodiment of the present invention;

FIG. 6 is a table showing the area division and a setting example of thresholds of the embodiment of the present invention;

FIG. 7 is a table showing a setting example of classifications of the embodiment of the present invention;

FIG. 8 is an image showing a display example of the embodiment of the present invention;

FIG. 9 is an image showing an example of operation control of the embodiment of the present invention; and

FIG. 10 is an image showing another example of an operation control of the embodiment of the present invention.

### DETAILED DESCRIPTION OF THE INVENTION

### Overall Configuration of Embodiment

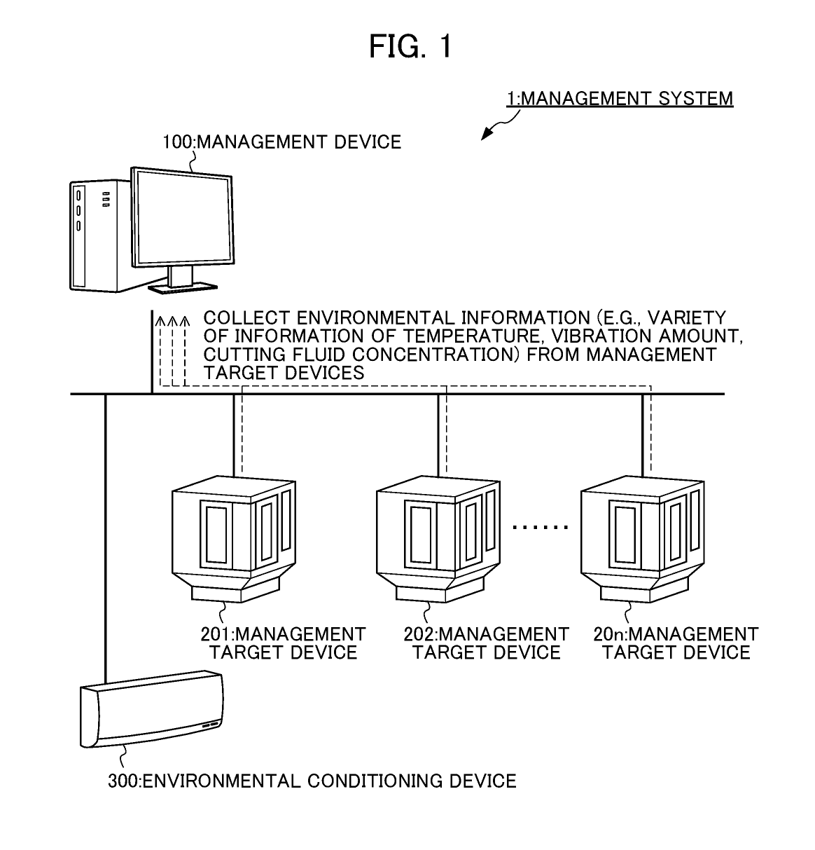

First, the configuration of a management system 1 according to the present embodiment will be explained. As shown in FIG. 1, the management system 1 includes a management device 100, management target device 201, management target device 202, management target device 20n (n is any natural number), and environmental conditioning device 300. The management system 1 is used by installing in a factory, for example.

These respective devices included in the management system 1 are connected to be communicable. This communication may be performed directly between respective devices, or may be via a network including relay devices. The network, for example, is realized by a LAN (Local Area Network) constructed in the factory, and/or a VPN (Virtual Private Network) constructed on the Internet.

It should be noted that, in the drawings, although the reference symbols are differentiated as “201”, “202” and “20n” in order to distinguish each of the respective management target devices, in the following explanation, explanation is made by attaching the reference symbol “200” to the management target device in the case of making explanation for the contents shared for each of the management target devices, without specifying which management target device.

The management device 100 is a device for monitoring the state of each management target device 200. The management device 100 is realized by a personal computer, server device, or the like. In addition, the management device 100 is utilized by a user managing the factory.

The management target device 200 is a group of a machine tool and a numerical control device which controls this machine tool. The management target device 200 performs predetermined machining by driving based on a machining program for realizing predetermined machining.

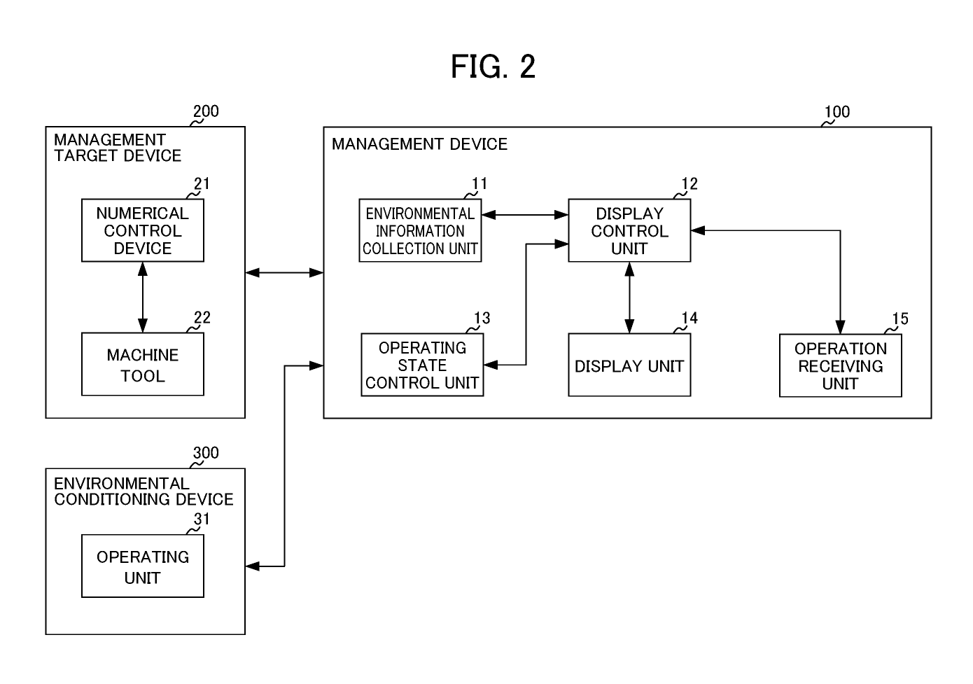

The environmental conditioning device 300 is a device for changing the state of the environment in which the management target device 200 is placed. The environmental conditioning device 300 is realized by an air conditioning device such as an air conditioner, and mist collector, for example. It should be noted that, in FIG. 1, a plurality of the management target devices 200 are described for explaining the collection of environmental information from the respective management target devices 200; whereas, only one is described for the environmental conditioning device 300. This is not intended for limiting the number of environmental conditioning devices 300 included in the management system 1, and a plurality of the environmental conditioning devices 300 may be included in the management system 1. Functional blocks included by these respective devices will be described later by referencing FIG. 2.

Next, an explanation will be made for an outline of the operations performed by the management system 1. In the management system 1, the management device 1 manages the entire factory in which the respective management target devices 200 are arranged by dividing into a plurality of areas. In addition, the management device 100 collects, from the respective management target devices 200, “environmental information”, which is information showing the state of the environment in which the respective management target devices 200 are placed, as illustrated. The environmental information includes information indicating the temperature, concentration of oil mist caused by cutting fluid, vibration amount, etc. in the environment in which the management target device 200 is placed, for example.

The management device 100 determines the state of the environment of each area based on the collected environmental information. Then, the management device 100 displays the state of the environment for each respective area determined, on a display unit to be associated with an image showing the arrangement (layout) of each management target device 200 in the factory. The user becomes able to perform state monitoring considering the arrangement of management target device, by referencing a display in which the state of the environment for each of these respective areas and an image showing the arrangement of the management target devices 200 are associated.

Furthermore, the management device 100 controls the operation states of the management target devices 200 and environmental conditioning device 300, based on the state of the environment for each of the respective areas. The management system 1 thereby becomes able to control the operation states of the management target device 200 and/or environmental conditioning device 300 based on the state of the environment, without requiring manipulation by the user. The above is a summary of operations of the overall management system 1.

<Functional Blocks Possessed by Management Device 100, Management Target Device 200 and Environmental Conditioning Device 300>

Next, explanations for the functional blocks possessed by the management device 100, management target device 200 and environmental conditioning device 300 will be made by referencing FIG. 2. The management device 100 includes an environmental information collection unit 11, display control unit 12, operating state control unit 13, operating state control unit 13 and display unit 14.

The environmental information collection unit 11 is a portion that collects environmental information from the respective management target devices 200. Information indicating the temperature, concentration of oil mist caused by cutting fluid, vibration amount, etc. is included in the environmental information as mentioned above. More specifically, the measurement values measured by sensors, etc. corresponding to these types of information are included. The collection of environmental information is performed at predetermined periods by the environmental information collection unit 11. For example, it is performed at a period of several [mm/sec].

However, it may be configured so as to differentiate the period for every type of environmental information according to the characteristics of the environmental information collected. For example, since the vibration amount changes suddenly, for the vibration amount, it may be configured so as to perform collection at a period of several [mm/sec] as mentioned above, and since the temperature does not change as suddenly, for the temperature, it may be configured so as to perform collection at a cycle on the order of once in several seconds. The environmental information collected by the environmental information collection unit 11 is outputted to the display control unit 12.

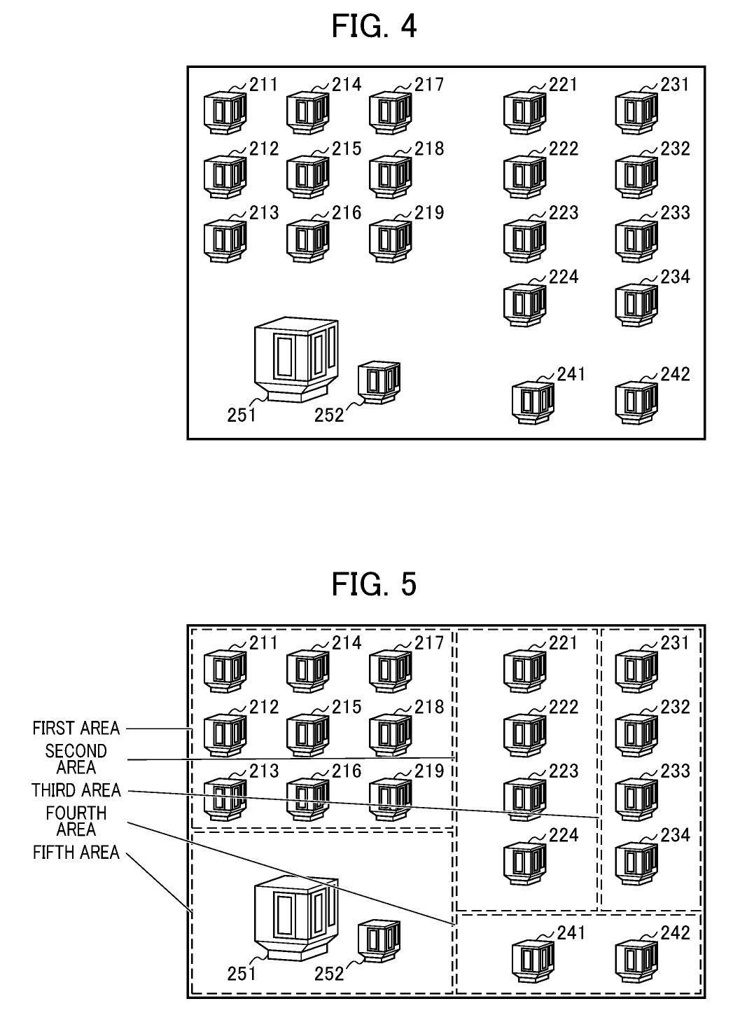

The display control unit 12 is a portion that performs control for performing display which associates the state of the environment for each of the aforementioned respective areas, and an image showing the arrangement of management target devices 200. The display control unit 12 performs setting of area division and setting of thresholds, based on manipulations from the user accepted by the operation receiving unit 15. Then, based on this setting, the display control unit 12 manages the entire factory in which the respective management target devices 200 are arranged by dividing into a plurality of areas. The details such as these settings of area division and thresholds will be described in detail by referencing FIGS. 4 to 6.

In addition, the display control unit 12 determines the state of the environment of each area based on the environmental information inputted from the environmental information collection unit 11. Then, the display control unit 12 outputs, to the display unit 14, image information for performing display associating the state of the environment for each of the determined respective areas, and an image showing the arrangement of the management target devices 200. The display unit 14 performs display based on this image information.

In addition, the display control unit 12 outputs, to the operating state control unit 13, the state of the environment for each of the determined respective areas. The operating state control unit 13 performs operation control on the management target device 200 and/or environmental conditioning device 300, based on the state of the environment of each of these respective areas.

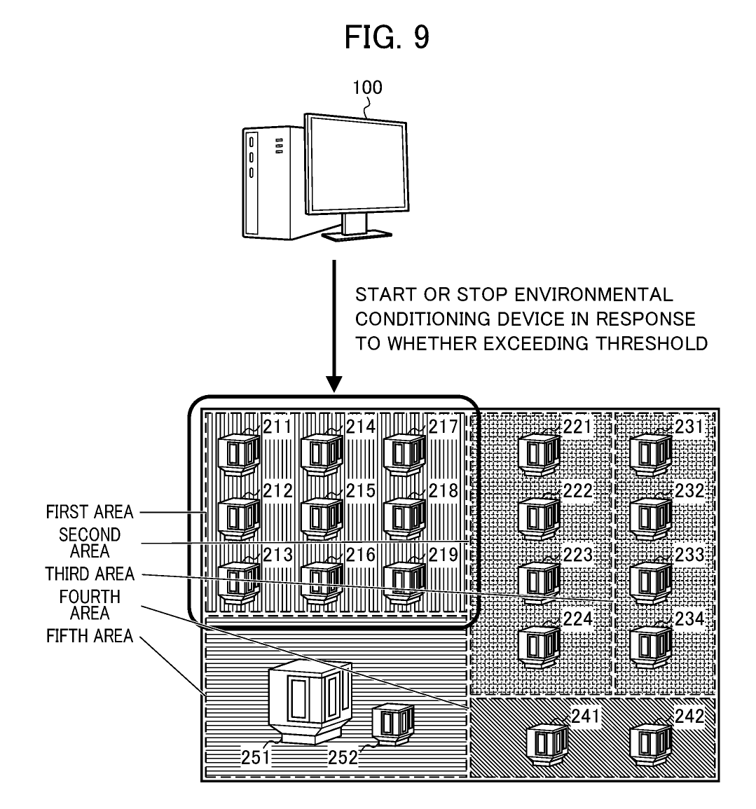

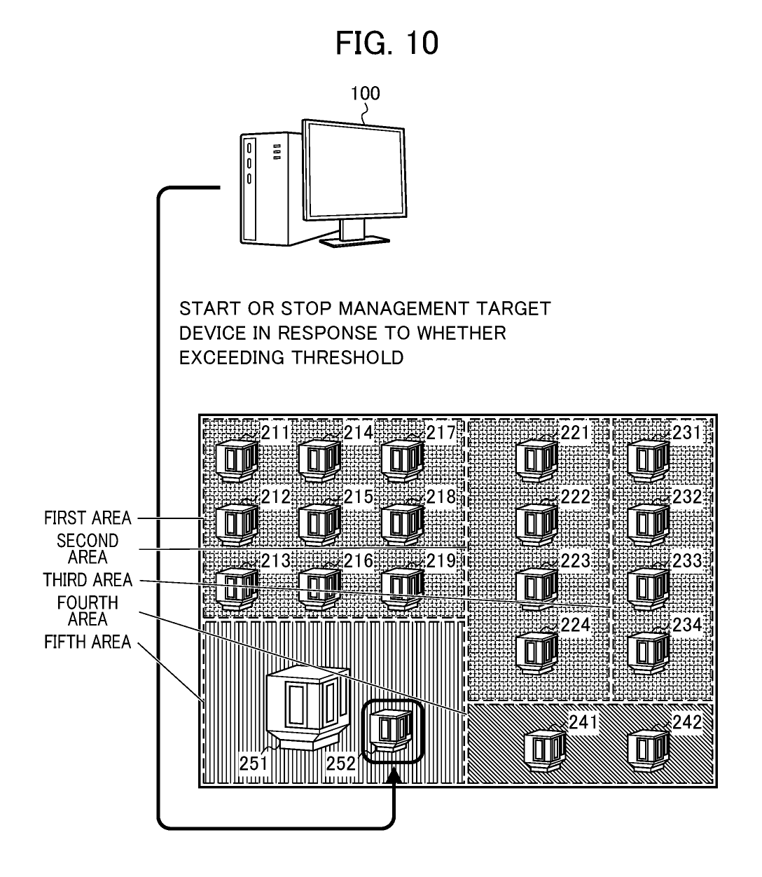

The operating state control unit 13 is a portion that controls the operating state of the management target device 200 and/or environmental conditioning device 300. Control of the operating state by the operating state control unit 13 will be described later by referencing FIGS. 9 and 10.

The display unit 14 is a portion displaying image information that was inputted from the display control unit 12. The display unit 14 is realized by a liquid crystal display or the like.

The operation receiving unit 15 is a portion that accepts manipulations from the user. The operation receiving unit 15 accepts, from the user, manipulations for performing settings of area divisions and thresholds, and manipulations for controlling the operating state of the management target device 200 and environmental conditioning device 300, for example. The operation receiving unit 15 outputs the accepted manipulation contents to the display control unit 12. The operation receiving unit 15 is realized by input devices such as a keyboard and mouse. It should be noted that it may be configured so as to realize the display unit 14 and operation receiving unit 15 integrally with a touch panel, for example.

The management target device 200 includes a numerical control device 21 and machine tool 22. The numerical control device 21 is a device that realizes predetermined machining by controlling driving such as of motors of the machine tool 22 based on a machining program for performing the predetermined machining.

In addition, the numerical control device 21 acquires environmental information in parallel with this control. For example, in the case of acquiring the temperature as environmental information, the numerical control device 21 acquires values measured by a temperature sensor installed in the vicinity of the management target device 200. In addition, in the case of acquiring the concentration of oil mist caused by cutting fluid as the environmental information, the numerical control device 21 acquires values measured by an oil-mist sensor installed in the vicinity of the management target device 200. In addition, in the case of acquiring the vibration amount as the environmental information, the numerical control device 21 acquires values measured by a sensor such as an acceleration sensor installed to a drive unit of the machine tool 22.

It should be noted that this information is ultimately just an example, and information other than this may be included in the environmental information. For example, it may be configured to include the value of the humidity measured by a hygrometer installed in the vicinity of the management target device 200, value of volume measured by an audio sensor installed in the vicinity of the management target device 200, or the like. In addition, the aforementioned respective sensors may be installed not only in the vicinity of the management target device 200, but directly to the management target device 200. In addition, other than the information measured by these sensors, it may be configured so as to collect information monitored by the numerical control device 21 such as information related to a shaft or tool of the machine tool 22, or information related to peripheral equipment relevant to the numerical control device 21 and machine tool 22, for example.

The numerical control device 21 generates environmental information by attaching identification information such as an ID for the management device 100 to identify the corresponding management target device 200 to these acquired values. Then, the numerical control device 21 sends the generated environmental information to the environmental information collection unit 11. The period of this sending is performed at a period of a several [mm/sec], for example, as mentioned above as the explanation of the environmental information collection unit 11.

The machine tool 22 is a device that executes predetermined machining such as cutting, by running in accordance with the control of the numerical control device 21. It should be noted that, since the specific configurations and functions of the numerical control device 21 and machine tool 22 are well known to those skilled in the art, detailed explanations thereof will be omitted.

The environmental conditioning device 300 includes an operating unit 31. The environmental conditioning device 300 is air conditioner or a mist collector for changing the state of the environment in which the management target device 200 is placed. Air conditioner is a cooling unit or ventilator, for example.

The operating unit 31 is a portion causing the function as this air conditioning equipment or mist collector to operate. The operating unit 31 changes the operating state based on the control of the display unit 14. Herein, change in operating state is the matter of switching between an starting state (ON state) and a stopped state (OFF state), for example. However, in more detail, it may be configured so as to change the intensity during startup. For example, in the case of the environmental conditioning device 300 being a cooling unit, it may be configured so as to change between performing cooling quickly (performing so-called strong operation), and performing cooling gently (performing so-called weak operation).

The functional blocks of the respective devices have been explained above. It should be noted that the aforementioned respective functional blocks are portions relevant to the present embodiment in particular, and the management device 100, management target device 200 and environmental conditioning device 300 include common functional blocks such as functional blocks for performing communication, for example, in addition to the aforementioned functional blocks.

The aforementioned management device 100, management target device 200 and environmental conditioning device 300 can be realized by incorporating a unique program of the present embodiment in common devices (for example, application programs). When explained in more detail, each of the aforementioned management device 100, management target device 200 and environmental conditioning device 300 includes an arithmetic processing unit such as a CPU (Central Processing Unit). In addition, each of the aforementioned management device 100, management target device 200 and environmental conditioning device 300 includes an auxiliary storage device such as a HDD (Hard Disk Drive) or SSD (Solid State Drive) storing various control programs, and a main storage device such as RAM (Random Access Memory) for storing data which is temporarily necessitated upon the arithmetic processing unit executing programs.

Then, in each of the aforementioned management device 100, management target device 200 and environmental conditioning device 300, the arithmetic processing unit reads out various programs from auxiliary storage device, and performs arithmetic processing based on this variety of programs, while expanding the various programs read out into the main storage device.

By controlling hardware possessed by each of the management device 100, management target device 200 and environmental conditioning device 300 based on this arithmetic processing, the functions of the aforementioned respective functional blocks are realized. In other words, the management device 100, management target device 200 and environmental conditioning device 300 can be realized by hardware and software cooperating.

### Operation of Present Embodiment

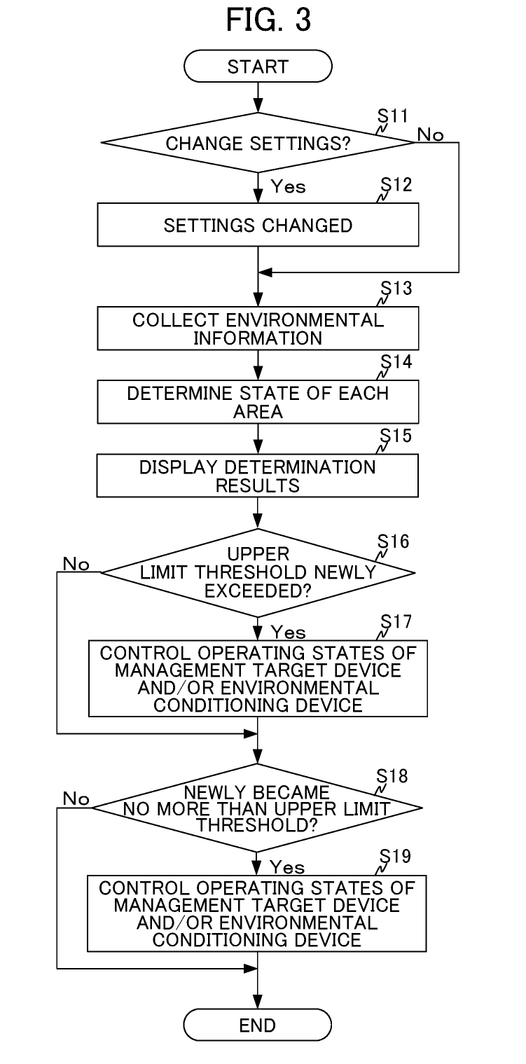

Next, an explanation will be made for the operation of the present embodiment, by referencing the flowchart of FIG. 3. In Step S11, the display control unit 12 determines whether or not to change the settings. Herein, determination is performed based on whether or not the operation receiving unit 15 has accepted a manipulation for changing the settings from the user. In the case of the operation receiving unit 15 having accepted a manipulation for changing the settings from the user, it is determined as YES in Step S11, and the processing advances to Step S12. On the other hand, in the case of the operation receiving unit 15 not accepting a manipulation for changing the settings from the user, it is determined as NO in Step S11, and the processing advances to Step S13.

In Step S12, the display control unit 12 causes an image for performing changes in settings to be displayed on the display unit 14. More specifically, it displays an image showing the arrangement of respective management target devices 200 in the factory as shown in FIG. 4. In the present example, the management target device 211 to management target device 252 are arranged in the factory, as shown in FIG. 4.

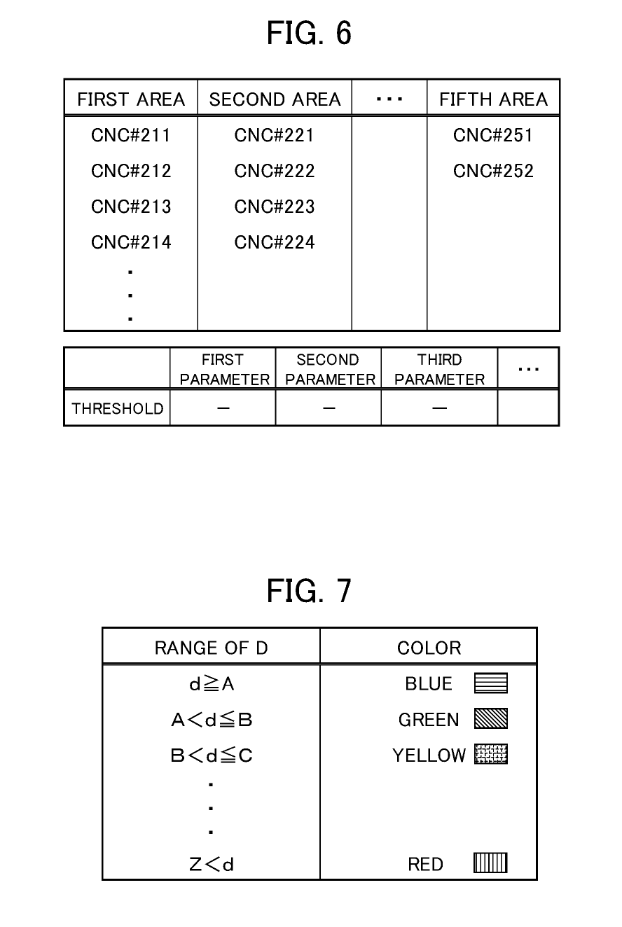

The user performs manipulations for performing area division on the operation receiving unit 15, while referencing this image. Manipulations are realized by a manipulation dragging a line for partitioning each area. The display control unit 12 performs area division as shown in FIG. 5, when the operation receiving unit 15 accepts such a manipulation, and allocates an identification number for identifying each area. Then, the display control unit 12 stores the identification number of each area and the identification number of management target devices 200 included in each area to be associated, as shown at the top of FIG. 6.

In the present example, area division is performed into five areas based on the manipulations of the user, and identification numbers of a first area to fifth area are allocated to each area. Presently, the management target device 211 to management target device 219 included in the first area are assumed as performing the same machining, respectively.

In addition, the management target device 221 to management target device 224 included in the second area are assumed as being one machining line. In other words, it is assumed that from the management target device 221 until the management target device 224 are a line creating one completed article by performing different machining in order on one workpiece. Furthermore, it is assumed that the management target device 231 to the management target device 234 included in the third area are one machining line, similarly to the management target device 221 to management target device 224 included in the second area.

The management target device 241 and management target device 242 included in the fourth area, and the management target device 251 and management target device 252 included in the fifth area are assumed as performing different machining, respectively. In particular, the management target device 251 is assumed to be larger scale than other management target devices 200, and to perform heavy machining. The user performs area division by considering the application, arrangement, etc. of such respective management target devices 200.

In addition, the display control unit 12 accepts setting manipulations of thresholds from the user via the operation receiving unit 15. The thresholds are set for every type of parameter. Herein, type of parameter is the type of information included in the environmental information. For example, in the case of temperature, vibration amount and the concentration of oil mist caused by cutting fluid being included in the environmental information, there is a parameter for each type of information in the environmental information. The thresholds are set for every parameter. Herein, although the thresholds set for each of the respective parameters may be only one, a plurality of thresholds shall be set step-wise for each of the respective parameters in the present embodiment. Then, the display control unit 12 stores the identification number of each parameter, and the plurality of thresholds set step-wise for each parameter to be associated, as shown at the bottom of FIG. 6. Among this plurality of thresholds set step-wise, the threshold having the largest value is called “upper limit threshold” hereinafter.

It should be noted that, as the explanation of Step S12 at this time, an explanation was made for changing both of the setting of area divisions and the setting of thresholds; however, only the setting of either one may be changed in Step S12. In addition, “change of settings” in Step S12 shall include the matter of performing setting newly during initial setting.

In Step S13, the environmental information collection unit 11 collects the environmental information. It should be noted that, since collection of environmental information in the aforementioned way is performed at a predetermined cycle, the collection of environmental information is continuously performed in parallel with the processing of each step explained below.

In Step S14, the display control unit 12 determines the state of the environment for each of the plurality of areas, based on the environmental information for each of the plurality of areas. In addition, the determination result of Step S14 is displayed in Step S15.

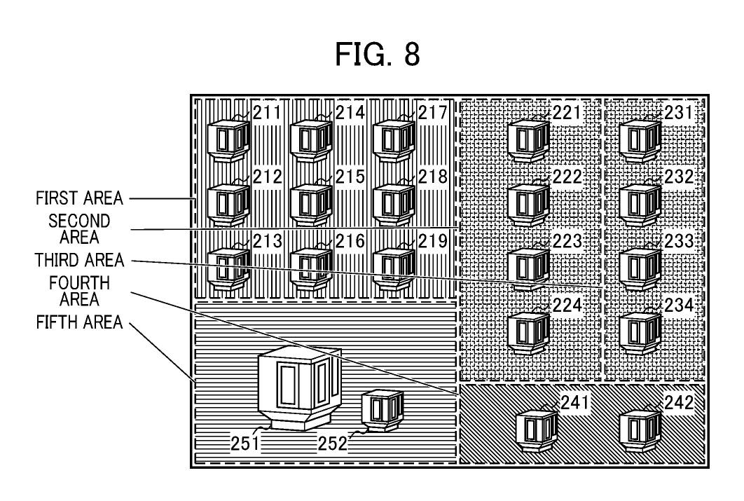

Explanations will be made for the determination method and display method of the display control unit 12 by referencing FIGS. 7 and 8. FIG. 7 is a table used by the display control unit 12 for performing determination. This table is created based on the plurality of thresholds set step-wise by the user. Determination is performed based on comparison between the value of any parameter included in the information, and the plurality of step-wise thresholds corresponding to this parameter.

It should be noted that, since the values for the plurality of management target devices 200 for one area are included in the environmental information, the highest value thereamong is defined as the target of comparison. For example, if the first area, since the values of each of the determination target device 211 to determination target device numerical control device 219 are included, the value that is the highest thereamong is defined as the target of comparison. However, this is merely one example, and it may be configured so as to define the average value for the values of the plurality of management target devices 200 as the target of comparison.

Herein, each of A, B, C . . . Z in the table corresponds to the value of the step-wise plurality of thresholds. It should be noted that the value of the threshold is set to larger values step-wise from A to Z. In addition, d in the table corresponds to a value included in the environmental information. Then, the display control unit 12, in the case of the value of d being less than the value of A, for example, due to being a relationship of “d≥A”, it is determined to perform area-fill display in blue, which is the corresponding color. Similarly, in the case of the value of d exceeding the value of A, but being no more than the value of B, due to being in the relationship of “A<d≤A”, it is determined to perform area-fill display in green, which is the corresponding color.

The display control unit 12 determines the state of the environment of each of the respective areas, and generates image information for area-fill displaying the color corresponding to the state of this environment on a picture showing the arrangement of the respective management target devices 200 shown in FIG. 5. Then, the display unit 14 performs display based on this image information. The display example of this case is shown in FIG. 8.

In the example shown in FIG. 8, for example, area-fill display in red is made in the first area, and display in yellow is made in the second area and third area. It should be noted that, due to restrictions in the description method of patent drawings, colors are realized by hatching. It should be noted that, in the present embodiment as mentioned above, it is assumed that a plurality of types of parameters are included in the environmental information. Then, there are also cases where the determination results differ according to parameters.

For example, for a certain area, a case is considered such that a problem will not arise for the parameter of temperature and the determination result is yellow; however, for the parameter of vibration amount, the vibration amount increases due to any problem and the determination result becomes red.

In this case, the display control unit 12 may be configured so as to do area-fill display according to the color corresponding to any determination result of the plurality of parameters. For example, if the above-mentioned example, it may be configured so as to do area-fill display in red rather than blue. In other words, among the thresholds exceeded by the respective parameters, it may be configured so as to do area-fill display according to the color corresponding to the highest threshold. In addition, rather than configuring in this way, it may be configured to be able to switch which of the plurality of the parameters to display, and it may be configured to do display corresponding to the switched parameter.

The user can collectively understand what kind of environment any of the areas is by referencing such a display. For this reason, it becomes possible to collectively manage the plurality of management target devices 200 in a single area, without managing each of the respective management target devices 200 individually.

In Step S16, the display control unit 12 determines whether or not the value included in the environmental information for any area in the determination in Step S14 of the current processing newly exceeded the upper limit threshold. In other words, it determines whether the area which had not exceeded the upper limit threshold thus far has newly exceeded the upper limit threshold.

This is because, in the case of a value included in the environmental information of any area having newly exceeded the upper limit threshold, switching of the operating state is performed by the operating state control unit 13. Herein, the upper limit threshold is a threshold of the largest value among the plurality of thresholds set step-wise as mentioned above, and Z corresponds to the upper limit threshold in the example of FIG. 7, for example.

In the case of a value included in the environmental information of any area newly exceeding the upper limit threshold, it is determined as YES in Step S16, and the processing advances to Step S17. On the other hand, in the case of a value included in the environmental information of any area not exceeding the upper limit threshold, it is determined as NO in Step S16, and the processing advances to Step S18.

In Step S17, the display control unit 12 issues an instruction to the operating state control unit 13, so as to control the operating state of the management target device 200 and/or environmental conditioning device 300. The operating state control unit 13 having received the instruction controls the operating state of the operating state control unit 13 based on the instruction. The control contents of the operating state differ according to the type of parameter determined as exceeding the upper limit threshold in Step S16. For example, in the case of being determined as exceeding the upper limit threshold for the parameter of temperature in the first area, the operating state of the cooling unit in the environmental conditioning device 300 installed in the first area for which the upper limit threshold was exceeded is turned to the ON state as a heat countermeasure, as shown in FIG. 9. It is thereby possible for the environmental conditioning device 300, which is the cooling unit, to start cooling to lower the temperature of the corresponding first area. For this reason, it is possible to prevent failure or the like due to heat of the management target device 200.

In addition, in the case of being determined as having exceeded the upper limit threshold for the parameter of cutting fluid concentration in the air in the first area, for example, the operating state of the mist collector in the environmental conditioning device 300 installed in the first area for which the upper limit threshold was exceeded is turned to the ON state as a cutting fluid countermeasure, as shown in FIG. 9. It is thereby possible to lower the cutting fluid concentration by way of the environmental conditioning device 300, which is the mist collector in the first area. For this reason, it is possible to decrease the influence on the human body, etc. by the cutting fluid concentration in the first area becoming higher.

In addition, in the case of being determined as having exceeded the upper limit threshold for the parameter of vibration amount and temperature in the fifth area, for example, the operating state of any of the management target devices 200 installed in the fifth area for which the upper limit threshold was exceeded is turned to the OFF state as a vibration countermeasure, as shown in FIG. 10. For example, in a case such that the control target device 251 is large scale, and when the control target device 251 is running, the vibration amount exceeds the upper limit threshold, and the influence appears in the machining by the control target device 252, the operating state of the control target device 252 is temporarily turned to the OFF state. It is thereby possible to reduce the influence on machining by the control target device 252.

In Step S18, the display control unit 12 determines whether or not a value included in the environmental information of any area in the determination of Step S14 in the current processing has newly become no more than an upper limit value threshold position. In other words, it is determined if an area for which the upper limit threshold was exceeded thus far newly became no more than the upper limit threshold. This is because, also in the case of a value included in the environmental information of any area having newly become no more than the upper limit threshold, switching of the operating state is performed by the operating state control unit 13.

In the case of a value included in the environmental information of any area having newly become no more than the upper limit threshold, it is determined as YES in Step S18, and the processing advances to Step S19. On the other hand, in the case of a value included in the environmental information in any area not having newly become no more than the upper limit threshold, it is determined as NO in Step S18, and the present processing ends once. Then, the aforementioned processing from Step S11 is repeated again.

In Step S19, the display control unit 12 outputs an instruction to the operating state control unit 13, so as to control the operating state of the management target device 200 and environmental conditioning device 300. The operating state control unit 13 having received an instruction controls the operating state of the operating state control unit 13 based on the instruction.

The control contents of the operating state differ according to the type of parameters determined as having become no more than the upper limit threshold in Step S18. For example, in the case of having determined as becoming no more than the upper limit threshold for the parameter of temperature in the first area, the operating state of the cooling unit within the environmental conditioning device 300 installed in the first area is turned to the OFF state. Since the environmental conditioning device 300 which is the cooling unit stops running, it is thereby possible to reduce the consumed electricity for this environmental conditioning device 300 running.

In addition, for example, in the case of being determined as becoming no more than the upper limit threshold for the parameter of cutting fluid concentration in the air in the first area, the operating state of the mist collector in the environmental conditioning device 300 installed in the first area is turned to the OFF state. Since the environmental conditioning device 300 which is the mist collector stops running, it is thereby possible to reduce the consumed electricity for this environmental conditioning device 300 running.

In addition, for example, in the case of being determined as having become no more than the upper limit threshold for the parameter of vibration amount in the first area, the operating state of any of the management target devices 200 installed in the fifth area is turned to the ON state. For example, in a case such that the control target device 251 is large scale, and when the control target device 251 is running, the vibration amount exceeds the upper limit threshold, and the influence appears in the machining by the control target device 252, since the operating state of the control target device 252 is temporarily turned to the OFF state, the operating state of this control target device 252 is turned to the ON state. Since the influences of vibrations emanating from the control target device 251 are not received, it is possible to realize machining by the control target device 251 in high precision.

When Step S19 ends, the present processing ends once. Then, the aforementioned processing from Step S11 is repeated again.

According to the above explained operations, the user becomes able to perform state monitoring taking consideration of the arrangement of management target devices, by referencing the display in which the state of the environment for each of the respective areas, and a picture showing the arrangement of management target devices 200 are associated, in Step S15.

In addition, from controlling the operating state according to Step S17 and Step S19, it becomes possible to control the operating state of the management target device 200 and/or environmental conditioning device 300 based on the state of the environment, without requiring manipulation by the user.

### <Effects Exerted by Present Embodiment>

Next, an explanation will be made for the effects exerted by the aforementioned present embodiment, including a comparison with the common technology. Even if the common technology as stated also in the section of Background of the Invention, it is possible to perform state monitoring of the individual management target devices (for example, machine tools), based on the data collected with the server.

However, even if state monitoring of individual management target devices is possible with the common technology, it will not be possible to perform state monitoring collectively by considering the arrangement of management target devices. At the location at which the management target devices in the factory are crowded, for example, the concentration of oil mist caused by cutting fluid in the air, temperature and vibration amount rise, and there is a possibility of failure of equipment and influencing the precision of machined article. Therefore, it has been desired to accurately decide the installation location of the environmental conditioning device (for example, air conditioning management equipment, mist collector, etc.) or the like, to make energy savings by running according to conditions, and to eliminate negative influences dependent on the layout.

In contrast, according to the present embodiment, it exerts an effect in that a user is able to easily recognize influences depending on the layout, by associating and visualizing environmental information collected as mentioned above and a picture showing the arrangement of management target devices 200 (layout diagram).

For this reason, according to the present embodiment, it exerts an effect of being able to improve the layout of the management target device 200 within the factory from the environmental information collected.

Furthermore, according to the present embodiment, it exerts an effect of being able to visualize the temperature distribution and the distribution of the concentration of oil mist caused by cutting fluid, and automate environment improvement, thereby preventing failure of the management target device 200.

Furthermore, according to the present embodiment, it exerts an effect in that mutual monitoring of the respective management target device 200 becomes possible by the management device 100, and as explained by exemplifying the fifth area, for example, scheduling of heavy machining taking consideration of the vibrations of adjacent management target devices 200 becomes possible. In addition, for another example, in a case such that the second area and third area are machining lines for performing the same machining, respectively, and in a case of a problem occurring in one machining line and stopping this one machining line, scheduling such that performs machining only in the required number by the other machining line becomes possible.

Furthermore, according to the present embodiment, from controlling the operating state of the management target device 200 and environmental conditioning device 300 based on the state of the environment, it exerts an effect in being able to contribute to cost savings by not running the environmental conditioning device 30 any more than necessary.

<Cooperation of Hardware and Software>

It should be noted that each of the respective devices included in the above-mentioned management system can be realized by hardware, software or combinations of these. In addition, the management method performed by each of the respective devices included in the above-mentioned management system can be realized by hardware, software or combinations of these. Herein, being realized by software indicates the matter of being realized by a computer reading and executing programs.

The programs can be stored using a variety of types of non-transitory computer readable media, and supplied to the computer. The non-transitory computer readable media includes varies types of tangible storage media. Examples of non-transitory computer readable media include magnetic media (for example, flexible disks, magnetic tape, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, RAM (random access memory)).

### MODIFIED EXAMPLES

In addition, the aforementioned embodiment is a preferred embodiment of the present invention; however, it is not to limit the scope of the invention to only the above-mentioned embodiment, and implementation is possible in modes arrived at by conducting various modifications in a scope no departing from the gist of the present invention.

### First Modified Example

In the aforementioned embodiment, a case is assumed in which the management device 100 manages the management target devices 200 installed in one factory. By modifying this, it may be configured so that the management device 100 manages management target devices 200 installed in a plurality of factories. In addition, in this case, it may be configured so as to provide a collection device which collects information within each factory, in which this collection device collects environmental information from the respective management target devices 200 within its factory, and this collection device sends this collected environmental information to the management device 100

### Second Modified Example

In the aforementioned embodiment, although it is explained by exemplifying the matter of performing processing with a machine tool or the like used in a factory as the management target device, the present embodiment may be configured so as to perform processing on another target. For example, in place of a machine tool, it may be configured so as to perform processing with an industrial robot as the management target device.

### Third Modified Example

In the aforementioned embodiment, area division was performed according to the settings of the user. By modifying this, it may be configured so that the management device 100 performs area division automatically, for example. For example, the management target devices 200 performing the same machining may be specified based on the contents of the machining program applied to the respective management target devices 200, and the region in which these management target devices 200 are arranged may be area divided as one area. In addition, for example, the management target devices 200 constituting a machining line may be specified based on the contents of the machining program applied to the respective management target devices 200, and the region in which these management target devices 200 are arranged may be area divided as one area.

### Fourth Modified Example

In the aforementioned embodiment, control of switching between the ON state and OFF state of the management target device 200 and/or environmental conditioning device 300 has been done based on whether or not a value included in the environmental information has exceeded the upper limit threshold. By modifying this, it may be configured so as to perform switching step-wise based on a plurality of thresholds. For example, in the case of the environmental conditioning device 200 being a cooling unit, it may be configured so as to perform quick cooling (perform so-called strong operation) in the case of exceeding the upper limit threshold, may be configured so as to perform gentle cooling (perform so-called weak operation) in the case of exceeding the threshold of a value of one stage lower than the upper limit threshold, and further may be configured so as to turn to the OFF state in a case of being no more than the threshold of a value one step lower than the upper limit threshold.

### Fifth Modified Example

In the aforementioned embodiment, the management device 100 automatically switched the operating state of the management target device 200 and/or environmental conditioning device 300. By modifying this, it may be further configured so as to switch the operating state in response to a manipulation by the user. In other words, in a case the user having referenced the display in Step S15 intending switch operating state of the management target device 200 and environmental conditioning device 300, it may be configured so as to accept a manipulation for switching at the operation receiving unit 15, and for the operating state control unit 13 to perform switching in response to this manipulation.

### EXPLANATION OF REFERENCE NUMERALS

1 management system
100 management device
200, 201-20n, 211-252 management target device
300 environmental conditioning device
11 environmental information collection unit
12 display control unit
13 operating state control unit
14 display unit
15 operation receiving unit
21 numerical control device
22 machine tool
31 operating unit

What is claimed is:

1. A management device comprising:
a collection unit that collects, from each of a plurality of management target devices disposed in a management target location, environmental information which is information indicating a state of an environment in which said management target device is placed; and
a display control unit that partitions the management target location into a plurality of regions, determines a state of an environment for each of the plurality of regions based on the environmental information collected by the collection unit, and displays the state of the environment for each of the plurality of regions thus determined on a display unit to be associated with a picture showing an arrangement of the management target devices in the management target location.

2. The management device according to claim 1, wherein the display control unit sets a threshold for a parameter included in the environmental information, and determines the state of the environment for each of the plurality of regions, based on whether the value of the parameter included in the environmental information collected by the collection unit is exceeding the threshold thus set.

3. The management device according to claim 2, wherein the display control unit determines step-wise the state of the environment for each of the plurality of regions by setting a plurality of the thresholds in a step-wise manner, and displays the state of the environment in a different mode according to which step a determined state is in.

4. The management device according to claim 3, wherein displaying in a different mode according to which step the determined state is in indicates the matter of displaying using a different color according to which step the determined state is in.

5. The management device according to claim 2, wherein the display control unit, in a case of collecting a plurality of sets of environmental information for a plurality of management target devices for one of the regions, performs the determination based on a highest value among values of parameters included in the plurality of sets of environmental information thus collected.

6. The management device according to claim 1, further comprising a first operating state control unit that controls an operating state of an environmental conditioning device that causes the state of the environment in which the management target device is placed to change, based on the state of the environment for each of the plurality of regions determined by the display control unit.

7. The management device according to claim 1, further comprising a second operating state control unit that controls an operating state of the management target device, based on the state of the environment for each of the plurality of regions determined by the display control unit.

8. The management device according to claim 1, wherein the display control unit partitions the management target location into a plurality of regions, based on a manipulation by a user referencing an image showing an arrangement of the management target devices in the management target location.

9. A management method performed by a computer, the method comprising the steps of:
collecting, from each of a plurality of management target devices disposed in a management target location, environmental information which is information indicating a state of an environment in which said management target device is placed; and
partitioning the management target location into a plurality of regions, determining a state of an environment of each of the plurality of regions based on the environmental information collected in the step of collecting, and displaying the state of the environment determined for each the plurality of regions on a display unit to be associated with an image showing an arrangement of the management target devices in the management target location.
